(19) United States
(12) Patent Application Publication
(10) Pub. No.: US 2023/0246506 A1
(43) Pub. Date: Aug. 3, 2023

(54) STATOR OF AN ELECTRIC MACHINE

(71) Applicant: Robert Bosch GmbH, Stuttgart (DE)

(72) Inventors: Alexander Siegert, Kornwestheim (DE); Hendrik Bachmann, Wetzlar (DE); Johannes Riedl, Bergheim (DE); Tobias Hein, Gronau (Leine) (DE)

(21) Appl. No.: 18/002,827

(22) PCT Filed: Jun. 14, 2021
(86) PCT No.: PCT/EP2021/065887

§ 371 Date: Dec. 21, 2022

(30) Foreign Application Priority Data
Jun. 24, 2020 (DE) 10 2020 207 804.1
Apr. 21, 2021 (DE) 10 2021 203 954.5

(51) Int. Cl. H02K 3/50

(52) U.S. Cl. CPC H02K 3/50; H02K 2203/09

(57) ABSTRACT

Described is a stator of an electric machine (1) comprising a stator body (5), more particularly stator laminated core, having a stator axis (4), and comprising an electrical plug-in winding (6) which extends through grooves (10) of the stator (2), comprises a plurality of phases and is formed from a plurality of conductor elements (7), wherein conductor elements (7) of the plurality of conductor elements (7) are provided, the conductor ends (8) of which project out of the grooves (10) at least at an end face (11) of the stator (2) and form a winding overhang (9), and comprising, provided on the winding overhang (9), an electrical terminal device (3) which has several busbars (15) for electrical connection to the plug-in winding (6) and by means of which the phases of the plug-in winding (6) can be connected to an external electrical power supply (16), characterised in that the busbars (15) each have at least one through opening (17) for introducing the respective conductor end (8) of at least one of the conductor elements (7) of one of the phases.

### BACKGROUND

The invention proceeds from a stator of an electric machine.

A stator of an electric machine is already known from US2018/040392 A, comprising a stator body, in particular a stator laminated core, having a stator axis, and comprising an electrical plug-in winding, which extends through grooves of the stator, comprises several phase conductors and is formed from a plurality of conductor elements, wherein conductor elements of the plurality of conductor elements are provided, the conductor ends of which project out of the grooves at least at an end face of the stator and form a winding overhang, and comprising an electrical terminal device provided on the winding overhang, which device has a plurality of busbars for electrical connection to the plug-in winding and by means of which device the phase conductors of the plug-in winding can be connected to an external electrical power supply. To weld the busbars of the terminal device to the conductor ends of the plug-in winding, the conductor ends to be joined are tensioned against the busbars with the aid of a tensioning tool and welded on the front side. In order to ensure sufficient and consistent process quality, the exact alignment of the conductor ends with the busbars of the terminal device is decisive.

### SUMMARY

By contrast, the stator of the electric machine according to the invention having the characterizing features of the main claim has the advantage that the exact alignment of the conductor ends to the busbars of the terminal device is not achieved by a tensioning tool but rather by the busbars themselves. The welding process in the production of the stator is significantly simplified by the elimination of the tensioning tools. This is achieved according to the present invention in that the busbars each have at least one through-opening for introducing the respective conductor end of at least one of the conductor elements of one of the phase conductors.

Advantageous further developments and improvements of the stator of the electric machine specified in the main claim are possible as a result of the measures listed in the subclaims.

It is particularly advantageous when the through-openings of the busbars each have a projecting collar, which is joined to and in particular welded to the conductor end of the respective conductor element. In this way, a good welding connection towards the respective busbar can be achieved, because the collar of the respective busbar is easily locally meltable by means of corresponding heat input. For busbars with sufficiently thin sheet thicknesses, the collars can also be omitted.

According to an advantageous embodiment, the projecting collar of the respective through-opening is formed, in particular deep-drawn or embossed, partially or completely circumferentially along an edge of the through-opening. In particular, the respective collar is designed to be completely circumferential without interruptions.

It is further advantageous when the respective through-opening of the respective busbar is configured in a longitudinal or slit-like or rectangular or circular or kidney-like fashion so as to receive one or more conductor ends, wherein the conductor element comprises a conductor cross-section having at least one cross-sectional dimension and the through-opening comprises at least one opening dimension, and wherein, between the opening dimension of the through-opening and the cross-sectional dimension of the conductor element, a fit that is suitable for welding is provided. According to the exemplary embodiment, the conductor element is a flat wire with a rectangular cross-section, having a wire height and a wire width, wherein the through-opening has an opening width and an opening length transverse to the extension of the conductor ends, and wherein a suitable fit, for example a clearance fit, is provided between the opening width of the through-opening and the wire width of the conductor end. In this way, a good alignment of the conductor ends with the busbars is achieved. In addition, this can result in the production of a good welding connection between the conductor ends of the conductor elements and the respective busbars.

It is very advantageous when the conductor end of the respective conductor element extends beyond the collar of the respective through-opening in an insertion direction. In this way, the conductor ends can be welded well to the respective busbar. In particular, droplets can be formed in this way during welding, which bridge the gap between the respective conductor end and the respective through-opening, thus introducing the heat required for welding into the respective busbar.

It is also advantageous when the respective through-opening of the respective busbar tapers in the insertion direction and, in particular, comprises insertion chamfers. In this way, the terminal device can be mounted or fitted onto the winding overhang as a unit, despite the presence of position tolerances. In this process, the corresponding conductor ends of the winding overhang are threaded simultaneously into the corresponding through-openings of the busbars of the terminal device.

Furthermore, is advantageous when the busbars each comprise a first terminal portion comprising the at least one through-opening for electrical connection to the plug-in winding, and when busbars are provided, each of which comprises a second terminal portion for electrical connection to an electrical phase of the external electrical power supply, and/or when a busbar is provided, which is electrically connected to all phase conductors of the plug-in winding and forms a star of an electrical star connection of the plug-in winding. In this way, the busbars are electrically connected according to the provided electrical connection.

In addition, it is advantageous when at least a first of the busbars and at least a second of the busbars are arranged one above the other when viewed axially with respect to the stator axis, such that the first busbar at least partially covers the second busbar while being spaced apart from one another, wherein the first busbar comprises a recess for providing access to the through-opening of the second busbar covered by the first busbar, said access being required for the welding, and/or that the second busbar comprises a recess for passing at least one of the conductor ends in order to connect to the through-opening of the first busbar. The recesses according to the invention enable a simple and automated assembly of the terminal device.

It is advantageous when the terminal device comprises an electrically insulating carrier for mounting the busbars, wherein the busbars are respectively fastened, and in particular caulked or hot-caulked, to the carrier. The carrier gathers all components of the terminal device into one unit, so that simple assembly of the terminal device is possible.

In addition, it is advantageous when the busbars are movable in the fastened state on the carrier, each with a specific clearance in the axial and/or radial direction and/or in the circumferential direction. In this way, the terminal device can be mounted or fitted onto the winding overhang as a unit, despite the presence of position tolerances.

According to an advantageous exemplary embodiment, it is provided that the carrier comprises a top side facing away from the plug-in winding and a bottom side facing the plug-in winding, wherein at least one, and in particular several or all, of the busbars is fastened on the top side of the carrier and/or at least one of the busbars is fastened to the bottom side.

It is further advantageous when at least one projecting insulating wall is formed on the carrier in order to electrically insulate two of the busbars against one another.

### BRIEF DESCRIPTION OF THE DRAWINGS

An exemplary embodiment of the invention is shown in simplified form in the drawings and explained in further detail in the following description.

FIG. 1 shows a sectional view of a stator of an electric machine having a terminal device according to the invention,

FIG. 2 shows a partial view of the terminal device according to FIG. 1 with the conductor ends 8 of the plug-in winding 6 to be joined according to FIG. 1,

FIG. 3 shows a view of a section through the terminal device according to FIG. 1 and FIG. 2, and

FIG. 4 shows a partial view of a further section through the terminal device according to FIG. 1 and FIG. 2.

### DETAILED DESCRIPTION

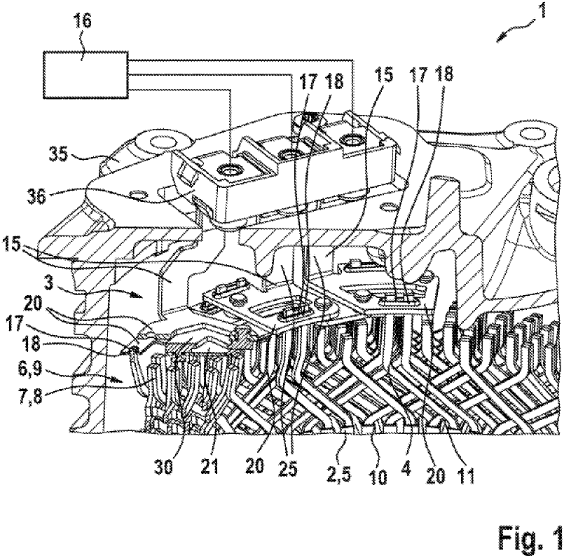

FIG. 1 shows a sectional view of a stator 2 of an electric machine 1 having a terminal device 3 according to the invention.

The stator 2 of the electric machine 1 comprises a stator body 5 having a stator axis 4, for example a stator laminated core, and an electrical plug-in 6. The plug-in winding 6 runs through grooves 10 of the stator 2, comprises several different electrical phase conductors, and is formed from a plurality of conductor elements 7. The conductor elements 7 can, for example, be made from flat wire with a rectangular cross-section and can be shaped like a hairpin or U-shaped or rod-shaped or I-shaped.

Alternatively, a circular wire with a circular cross-section could also be provided. The conductor elements 7 have an electrical insulating coating in a known manner (not shown).

Conductor elements 7 of the plurality of conductor elements 7 are provided, the conductor ends 8 of which project out of the grooves 10 at least at an end face 11 of the stator 2 and form a winding overhang 9.

In addition, the stator 2 comprises the electrical terminal device 3 arranged on the winding overhang 9, which comprises several busbars 15 for electrical connection to the plug-in winding 6 and by means of which the phase conductors of the plug-in winding 6 can be connected to an external electrical power supply 16. The busbars 15 are configured as a stamped bending part, for example.

According to the invention, it is provided that the busbars 15 each have at least one through-opening 17 for introducing the respective conductor end 8 of at least one of the conductor elements 7 of one of the phase conductors. The conductor ends 8 arranged in the through-openings 17 are joined, and in particular welded, to the respective busbars 15.

The through-opening 17 is understood to mean an opening or recess that continuously passes through the respective busbar 15 from one side to the opposite side, for example such that a conductor end 8 of one of the conductor elements 7 can project through the through-opening 17. The through-opening 17 can have a circumferentially closed or non-closed circumferential boundary contour or surface that forms an edge of the through-opening 17.

For example, the through-openings 17 of the busbars 15 can each have a projecting collar 18 which is joined, and in particular welded, to the conductor end 8 of the respective conductor element 7. In FIG. 1, the joining connections between the busbars 15 and the respective conductor elements 7 are not shown.

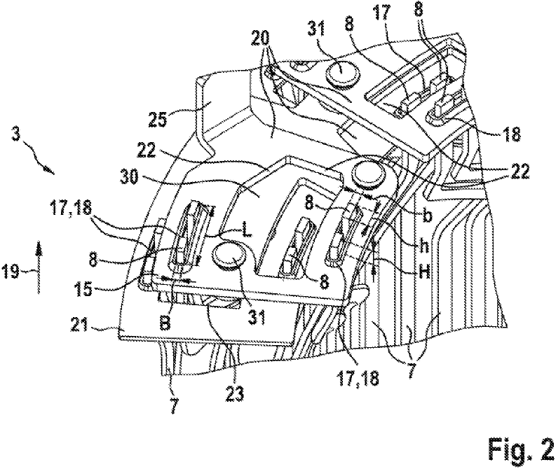

FIG. 2 shows a partial view of the terminal device 3 according to FIG. 1 with the conductor ends 8 of the plug-in winding 6 to be connected according to FIG. 1.

According to the exemplary embodiment, the projecting collar 18 of the respective through-opening 17 is configured along an edge of the respective through-opening 17, for example completely circumferentially, and is produced by, for example, deep-drawing or embossing. Alternatively, the collar 18 can also be configured circumferentially in portions.

The at least one through-opening 17 of the respective busbar 15 is configured to receive one or more conductor ends 8, for example, in a longitudinal or slit-like or rectangular or circular or kidney-like manner. According to the exemplary embodiment in FIG. 1 and FIG. 2, two conductor ends 8 are arranged in each through-opening 17.

The respective through-opening 17 has an opening width B and an opening length L transverse to the extension of the conductor ends 8. The rectangular cross-section of the conductor elements 7 has a wire height h and a wire width b. between the opening width B of the respective through-opening 17 and the wire width b of the respective conductor end 8, a fit that is suitable for welding is provided. The opening width B of the respective through-opening 17 thus essentially corresponds to the wire width b of the corresponding conductor end 8 or is slightly larger than the wire width b of the corresponding conductor end 8.

The conductor end 8 of the respective conductor element 7 extends in an insertion direction 19 and with a projection H beyond the collar 18 of the respective through-opening 17.

All busbars 15 each have a first terminal portion 20 comprising the at least one through-opening 17 for electrical connection to the plug-in winding 6. Furthermore, all busbars 15, or, according to the exemplary embodiment, all busbars 15 with the exception of one busbar 15, each have a second terminal portion 25 for electrical connection to an electrical phase of the external electrical power supply 16. According to the first alternative, a delta connection can be achieved, wherein the number of busbars 15 corresponds to the number of electrical phases. According to the second alternative and according to the exemplary embodiment, a star connection is achieved by means of terminal device 3, wherein the number of busbars 15 is one greater than the number of electrical phases. For the star connection, one of the busbars 15 is provided having no second terminal portion 25, is electrically connected to all phase conductors of the plug-in winding 6, and thereby forms a star 21 of the electrical star connection of the plug-in winding 6.

According to FIG. 1 and FIG. 2, at least one first, for example upper, of the busbars 15 and at least one second, for example lower, of the busbars 15 are arranged one above the other when viewed axially with respect to the stator axis 4, such that the first busbar 15 at least partially covers the second busbar 15 while being spaced apart from one another. The at least one first busbar 15 therefore comprises a recess 22 for providing access to the through-opening 17 of the second busbar 15 covered by the first busbar 15, said access being required for the joining. The second, for example lower, busbar 15 can comprise a recess 23 for passing at least one of the conductor ends 8 for connection to the through-opening 17 of the first busbar 15.

The terminal device 3 can comprise an electrically insulating carrier 30 for mounting the busbars 15, wherein the busbars 15 are respectively fastened, for example caulked or hot-caulked, to the carrier 30. The carrier 30 has a top side facing away from the plug-in winding 6 and a bottom side facing the plug-in winding 6. At least one or several or all of the busbars 15, for example only the busbars 15 with the second terminal portion 25, are fastened to the top of the carrier 30. At least one of the busbars 15, for example the busbar 15 forming the star 21, can be fastened to the bottom of the carrier 30. Projecting, for example rib-shaped, insulating walls (not shown) can be formed on the carrier 30, which are arranged such that two of the busbars 15 are respectively electrically insulated against one another.

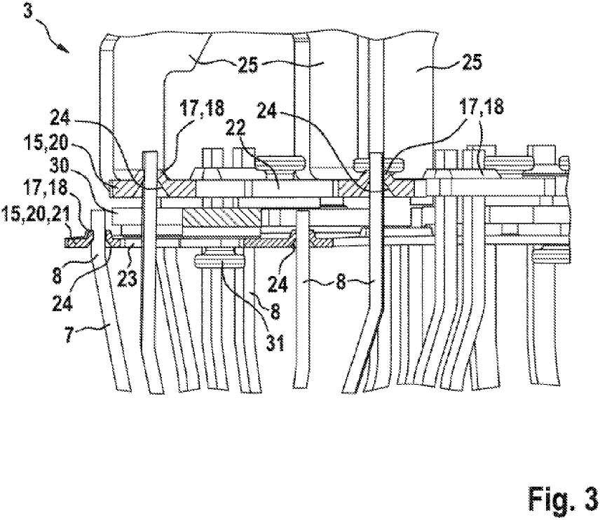

FIG. 3 shows a view of a section through the terminal device according to FIG. 1 and FIG. 2.

The respective through-opening 17 of the respective busbar 15 tapers in the insertion direction 19 and, in particular, comprises insertion chamfers (24).

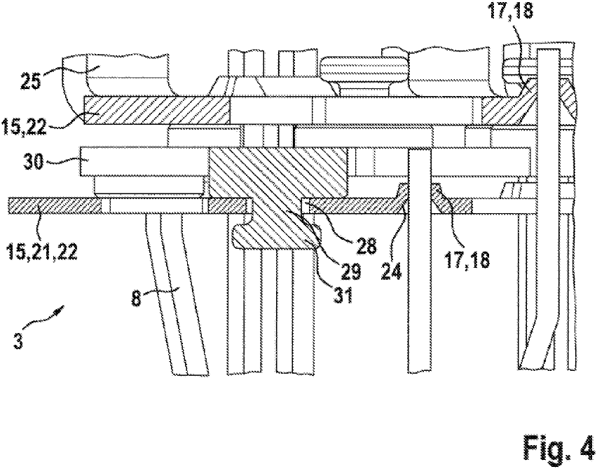

FIG. 4 shows a partial view of a further section through the terminal device according to FIG. 1 and FIG. 2.

For example, to fasten the busbars 15 to the carrier 30, the busbars 15 each have at least one fastening through-opening 28, and the carrier 30 comprises a fastening pin 29 that respectively extends through the fastening through-opening 28 of the busbar 15. The respective fastening pin 29 of the carrier 30 is, for example, shaped at its free end to form a retaining overhang 31, which is configured so as to fix the respective busbar 15 to the carrier 30.

As can be seen from FIG. 4, the busbars 15 are movable in the fastened state on the carrier 30, for example in each case with a specific clearance in the axial and/or radial direction and/or in the circumferential direction relative to the stator axis 4. This is achieved in that a clearance is provided between the fastening through-opening 28 and the fastening pin 29 and in that the retaining overhang 31 does not abut against the busbar 15, but rather a corresponding spacing is formed.

For example, the stator 2 is arranged in a housing 35 of the electric machine 1. The terminal device 3 is electrically connected, for example via the second terminal portions 25 of the corresponding busbars 15, to a phase terminal unit 36, which is fastened to the housing 35 and comprises several phase terminals. The individual phase terminals of the phase terminal unit 36 are each electrically connectable to one of the electrical phases of the external power supply 16.

1. A stator of an electric machine (1) comprising: a stator body (5) having a stator axis (4), and an electrical plug-in winding (6), which extends through grooves (10) of the stator (2), includes several phase conductors, and is formed from a plurality of conductor elements (7), wherein conductor elements (7) of the plurality of conductor elements (7) are provided with conductor ends (8) which project out of the grooves (10) at least at an end face (11) of the stator (2) and form a winding overhang (9), and the stator further comprising an electrical terminal device (3) provided on the winding overhang (9), which device has several busbars (15) for electrical connection to the plug-in winding (6) and wherein the phase conductors of the plug-in winding (6) can be connected to an external electrical power supply (16), wherein
the busbars (15) each have at least one through-opening (17) for introducing the respective conductor end (8) of at least one of the conductor elements (7) of one of the phase conductors.

2. The stator according to claim 1, wherein the through-openings (17) of the busbars (15) each have a projecting collar (18), which is joined to the conductor end (8) of the respective conductor element (7).

3. The stator according to claim 2, wherein the projecting collar (18) of the respective through-opening (17) is formed partially or completely circumferentially along an edge of the through-opening (17).

4. The stator according to claim 1, wherein the respective through-opening (17) of the respective busbar (15) is configured in a longitudinal or slit-like or rectangular or circular or kidney-like fashion so as to receive one or more conductor ends (8), wherein the conductor element (7) comprises a conductor cross-section having at least one cross-sectional dimension (h,b) and the through-opening (17) comprises at least one opening dimension (B,L), and wherein, between the opening dimension (B,L) of the through-opening (17) and the cross-sectional dimension (h,b) of the conductor element (7), a fit that is suitable for welding is provided.

5. The stator according to claim 2, wherein the conductor end (8) of the respective conductor element (7) extends beyond the collar (18) of the respective through-opening (17) in an insertion direction (19).

6. The stator according to claim 5, wherein the respective through-opening (17) of the respective busbar (15) tapers in the insertion direction (19).

7. The stator according to claim 1, wherein the busbars (15) each comprise a first terminal portion (20) including the at least one through-opening (17) for electrical connection to the plug-in winding (6) and that busbars (15) are provided, each of which includes a second terminal portion (25) for electrical connection to an electrical phase of the external electrical power supply (16), and/or that a busbar (15) is provided, which is electrically connected to all phase conductors of the plug-in winding (6) and forms a star (21) of an electrical star connection of the plug-in winding (6).

8. The stator according to claim 1, wherein at least a first of the busbars (15) and at least a second of the busbars (15) are arranged one above the other when viewed axially with respect to the stator axis (4), such that the first busbar (15) at least partially covers the second busbar (15) while being spaced apart from one another, wherein the first busbar (15) comprises a recess (22) for providing access to the through-opening (17) of the second busbar (15) covered by the first busbar (15) and/or that the second busbar (15) comprises a recess (23) for passing at least one of the conductor ends (8) in order to connect to the through-opening (17) of the first busbar (15).

9. The stator according to claim 1, wherein the terminal device (3) comprises an electrically insulating carrier (30) for mounting the busbars (15), wherein the busbars (15) are respectively fastened to the carrier (30).

10. The stator according to claim 9, wherein the busbars (15) are movable in the fastened state on the carrier (30), each with a clearance, in an axial and/or radial direction and/or in a circumferential direction relative to the stator axis (4).

11. The stator according to claim 9, wherein the carrier (30) comprises a top side facing away from the plug-in winding (6) and a bottom side facing the plug-in winding (6), wherein at least one of the busbars (15) is fastened on the top side of the carrier (30) and/or at least one of the busbars (15) is fastened to the bottom side.

12. The stator according to claim 9, wherein at least one projecting insulating wall is formed on the carrier (30) in order to electrically insulate two of the busbars (15) against one another.

13. An electrical machine having a housing (35) and a stator (2) arranged in the housing (35) according to claim 1.

14. The stator according to claim 1, wherein the stator body (5) is a stator laminated core.

15. The stator according to claim 2, wherein each projecting collar (18) is welded to the conductor end (8) of the respective conductor element (7).

16. The stator according to claim 3, wherein the projecting collar (18) of the respective through-opening (17) is deep-drawn or embossed.

17. The stator according to claim 6, wherein the respective through-opening (17) of the respective busbar (15) includes insertion chamfers (24).

18. The stator according to claim 9 wherein the busbars (15) are respectively caulked or hot-caulked to the carrier (30).

19. The stator according to claim 11, wherein the carrier (30) comprises a top side facing away from the plug-in winding (6) and a bottom side facing the plug-in winding (6), wherein several or all of the busbars (15) are fastened on the top side of the carrier (30).
